(19) United States
(12) Patent Application Publication
(10) Pub. No.: US 2025/0075851 A1
(43) Pub. Date: Mar. 6, 2025

(54) Object Holding Device

(71) Applicant: Lufalok, Lemont, IL (US)

(72) Inventor: Daniel Merrion, Lemont, IL (US)

(21) Appl. No.: 18/822,247

(22) Filed: Sep. 1, 2024

Related U.S. Application Data
(60) Provisional application No. 63/536,397, filed on Sep. 2, 2023.

(51) Int. Cl. F16M 13/02; A47K 7/02; F16B 47/00

(52) U.S. Cl. CPC F16M 13/022; F16B 47/00; A47K 7/02

(57) ABSTRACT

An object holding device includes a base having a holder side and an attachment side. An attachment feature is provided on or defined by the attachment side. A holder protrudes from the holder side and forms a retention area configured to hold an object.

### BACKGROUND

### 1. Field of the Disclosure

The present disclosure is generally directed to a luffa holding device and, more particularly, to a luffa holding device having a luffa holder and being configured to attach to a surface.

### 2. Description of Related Art

A luffa is a popular bathing accessory used for cleaning and exfoliating skin. Generally, dead skin cells may clump around the top layer of a person's skin, making for a duller and less youthful appearance. Luffas scrub this layer off gently and without disrupting the young and healthy skin cells underneath. However, a luffa may harbor dead skin and dirt from the body when stored inside a damp shower and thus bacteria may start to cultivate on the luffa. Specifically, not storing a luffa in a manner so it can easily dry and instead leaving it on a surface of a bathtub may cause it to remain moist and harbor bacteria.

Also, it can be difficult for a user to scrub their back or other difficult to reach body parts with a conventional luffa. The luffa is hand held and most people have difficulty reaching some parts of their body, such as their middle and/or upper and lower back. A conventional luffa is typically stowed by hanging the luffa from a rope or cord and thus is not useful in scrubbing any part of a user's body when stowed in this manner. The luffa must typically be removed from the stowed or hanging position and then used by hand to scrub the user's body.

Furthermore, showers and bathtub areas can be tough to keep organized because they're not always built with storage in mind. Some shower and bathtub areas have cubbies or shelves where one can keep bottled bathing products and soaps. However, other shower and bathtub areas or bathrooms are limited to a window ledge or a bathtub ledge for storage. The limited amount of space in showers and bathtubs makes it difficult to store your luffa within reaching distance while at the same time allowing the luffa to dry when not in use. Thus, the foregoing problems can lead to improper storage for luffas, inconvenience, and disorganization.

These types of issues and problems are common in other areas as well. Workshops, car detailing venues, offices, kitchens, labs, and other such environments have similar issues. The tools, objects, utensils, products, and cleaning supplies, such as sponges, chamois, cloth towels, applicators, rags, and the like, in these types of environments are best not placed or dropped on the ground or on common surfaces between uses. Otherwise, these supplies can become dirty, soiled, or otherwise contaminated and can also grow bacteria. However, such objects or supplies are typically mishandled or poorly handled, stowed, or stored between uses in these environments. The wet or used supplies may be slung over buckets during or after use or may be laid on dirty surfaces or on just cleaned surfaces during use because it is easier than finding any nearby temporary solution for temporarily holding such objects or supplies.

### SUMMARY

In one example according to the teachings of the present disclosure, an object holding device includes a base having a holder side and an attachment side. An attachment feature is provided on or defined by the attachment side. A holder protrudes from the holder side and forms a retention area configured to hold an object.

In one example, the attachment feature can be a suction cup configured to retain the base attached to a surface via suction.

In one example, the attachment side can include a release tab configured to release the base when it is attached to a surface via suction of the attachment feature, such as a suction cup.

In one example, the holder can include two or more petals protruding from the holder side of the base. The petals can be spaced apart from one another to define the retention area.

In one example, the holder can include three petals spaced apart from one another. Each petal can have an inward facing surface facing generally in a direction toward the other two petals of the three petals.

In one example, the holder may include three petals that are spaced equidistant apart from one another on the holder side of the base.

In one example, the holder may include a plurality of petals. At least part of an inward facing surface of each petal can be concave in a direction toward the other two of the plurality of petals.

In one example, the holder can have a gripping feature configured to aid in retaining an object in place when positioned in the retention area.

In one example, the holder can have a gripping feature that includes a plurality of protrusions that protrude from an inward facing surface of a part of the holder.

In one example, the holder can include at least three petals protruding from the holder side of the base. The at least three petals can be spaced apart from one another to define the retention area. The at least three petals can each include a plurality of protrusions that protrudes from an inward facing surface of each petal of the at least three petals. The plurality of protrusions can be positioned at least nearer a distal or free end of each petal.

In one example, the base and the holder can be an integral one-piece molded structure.

In one example, the object holding device can be made from a water-resistant material, a flexible material, a resilient material, a rubber material, or any combination thereof.

In one example, the base can be circular in shape. In other examples, the base can have or include a shape that is circular, oval, elliptical, rectangular, square, triangular, trapezoidal, or polygonal in shape, or any combination thereof.

In one example, the base can be configured to define a suction cup as the attachment feature.

In one example, the retention area of the holder can be configured to hold a luffa.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention should become more apparent upon reading the following description in conjunction with the drawings.

FIG. 1 is a perspective view of an embodiment of an object holding device according to the teachings of the present disclosure and attached to a surface.

FIG. 2 is a perspective view of the object holding device of FIG. 1 holding a luffa.

FIG. 3 is a front perspective view of an embodiment of an object holding device according to the teachings of the present disclosure.

FIG. 4 is a rear perspective view of the object holding device of FIG. 3.

FIG. 5 is a front view of the object holding device of FIG. 3.

FIG. 6 is a rear view of the object holding device of FIG. 3.

FIGS. 7-10 are various side views of the object holding device of FIG. 3.

FIG. 11 is a cross-section view taken along line 11-11 of the object holding device of FIG. 5.

FIG. 12 is a cross-section view taken along line 12-12 of the object holding device of FIG. 5.

FIG. 13 is a cross-section view taken along line 13-13 of the object holding device of FIG. 2 holding a luffa.

FIG. 14 is a perspective view of another embodiment of an object holding device according to the teachings of the present disclosure.

FIG. 15 is a cross-section view taken along line 15-15 of the object holding device of FIG. 14.

FIG. 16 is a perspective view of another embodiment of an object holding device according to the teachings of the present disclosure.

FIG. 17 is a cross-section view taken along line 17-17 of the object holding device of FIG. 16.

FIG. 18 is a perspective view of another embodiment of an object holding device according to the teachings of the present disclosure.

FIG. 19 is a cross-section view taken along line 19-19 of the object holding device of FIG. 18.

### DETAILED DESCRIPTION OF THE DISCLOSURE

Various cleaning supplies, luffas, and the like are known in the art to hang from existing support structures using ropes and the like. The support structures for luffas are typically objects found in a bathroom, such as a faucet head or the like. The support structures in other environments are similar in nature and may be a hook, a knob, a door handle, or an open space on a surface. This limits the locations in which a luffa or cleaning supplies can be stowed. In the case of a luffa, this prevents the luffa from being used to scrub a user's body when stowed. In contrast, the disclosed object holding device is designed to securely hold and/or grip an object, such as a luffa or a chamois, while also being suctioned in place to any suitable surface in a bathroom or other work environment.

This makes storing the cleaning objects, such as a luffa, for drying and for next use much more convenient. This also make the luffa useful to scrub hard to reach places on a user's body. The holding device can be conveniently positioned in a desired location and attached to a surface in a tub or shower area, on a car window, on a clean flat surface, or the like. The cleaning object may then be retained in the holder. In the case of a luffa, the user can then scrub their back or other hard to reach body parts using the luffa as it is held by the holding device instead of in the user's hand.

The disclosure describes and shows various embodiments and examples of an object holding device having gripping features to grip/hold an object, such as a luffa, and having an attachment feature configured to attach the object holding device to a surface. Objects, features, and advantages of the disclosed embodiments and examples should become apparent to those having ordinary skill in the art upon reading this disclosure.

The specification does not necessarily describe all elements of various embodiments of the present disclosure. Descriptions of elements or components well-known in the art to which the present disclosure pertains or overlapping or repetitive descriptions have been omitted.

It should be understood that, when an element is referred to as being “connected” to another element, it can be directly or indirectly connected to the other element. An indirect connection includes one or more intervening elements or parts among or between two connected elements.

It should be understood that the terms “include,” “comprise”, “have,” and the like, and variations thereof, when used in the present disclosure, specify the presence of stated features, integers, steps, operations, elements, and/or components. The terms do not preclude the presence or addition of one or more other features, integers, steps, operations, elements, components, and/or groups thereof.

It should be understood that, where it is stated in the present disclosure that an element is located “on” another element, the element may be in direct contact with the other element or, yet another element may be present between the one element “on” the other element.

It should be understood that, although the terms first, second, etc., and other such similar terms may be used herein to describe various elements, these elements should not be limited by these terms. These types of terms are used merely to distinguish among various elements, unless expressly stated to the contrary. Similarly, the terms “up,” “upward,” “down,” “downward,” and the like are used for reference as relative directional terms. It should be understood that these terms are also not strictly limiting, unless expressly stated herein.

It should be understood that the use of singular forms is intended to include the plural forms as well unless the context clearly dictates otherwise. Further, when a component, device, element, or the like of the present disclosure is described as having a purpose or performing an operation, function, or the like, the component, device, or element should be considered herein as being “configured to” meet that purpose or perform that operation or function.

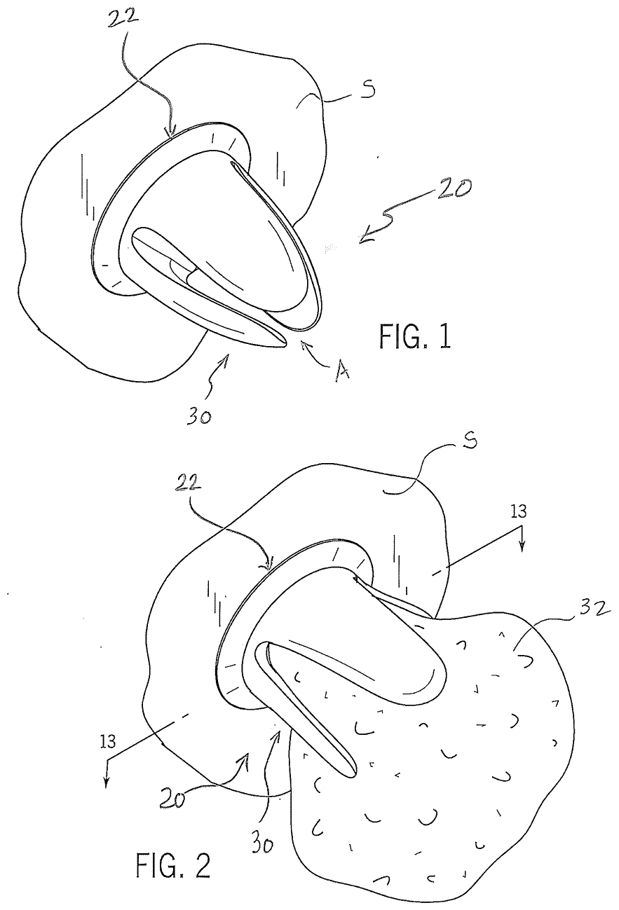

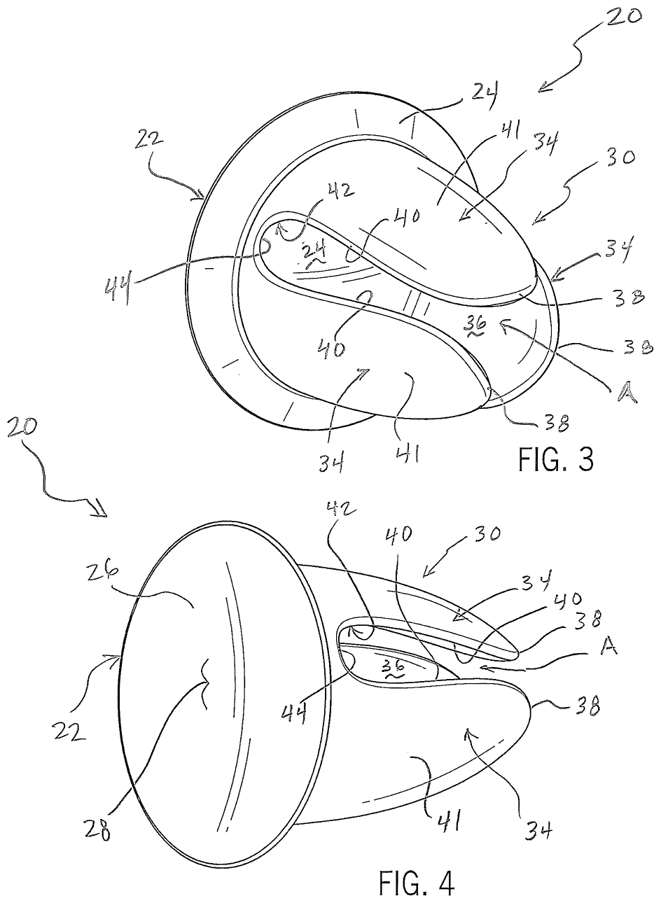

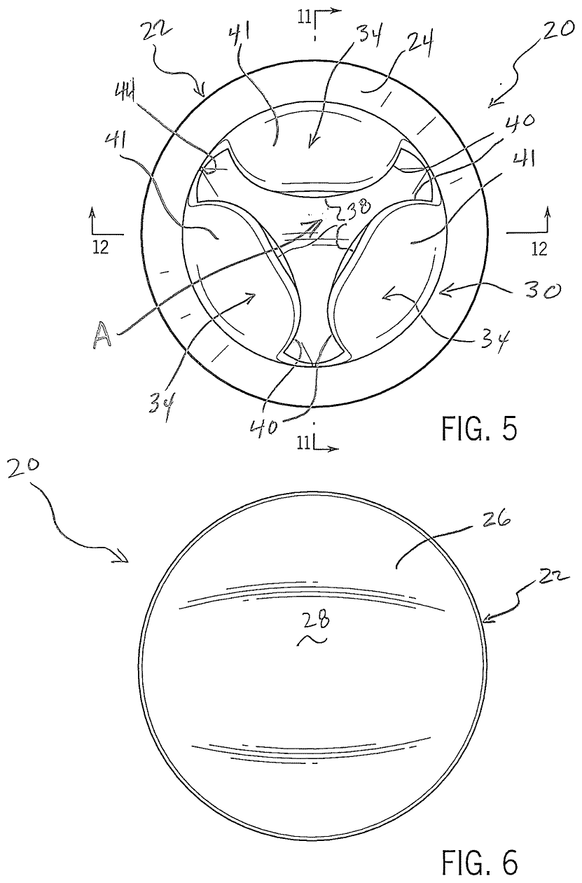

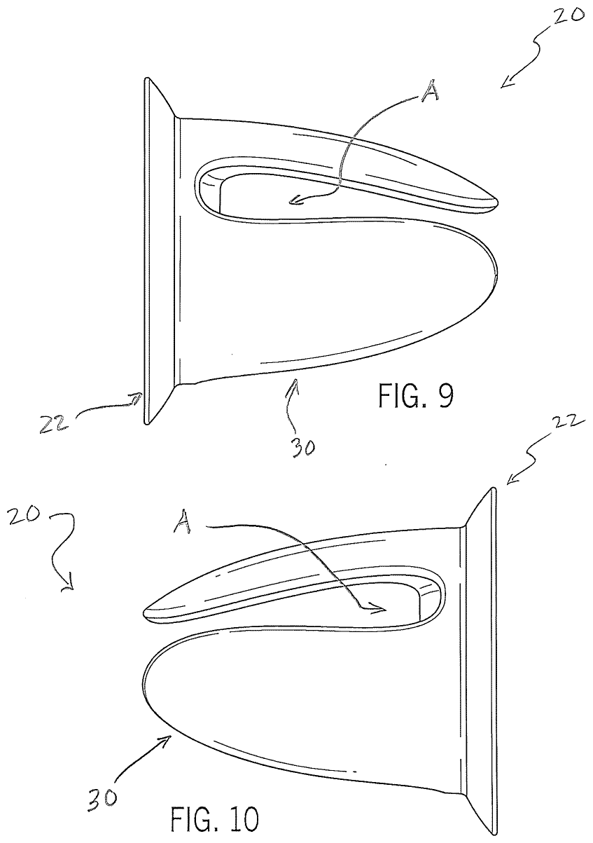

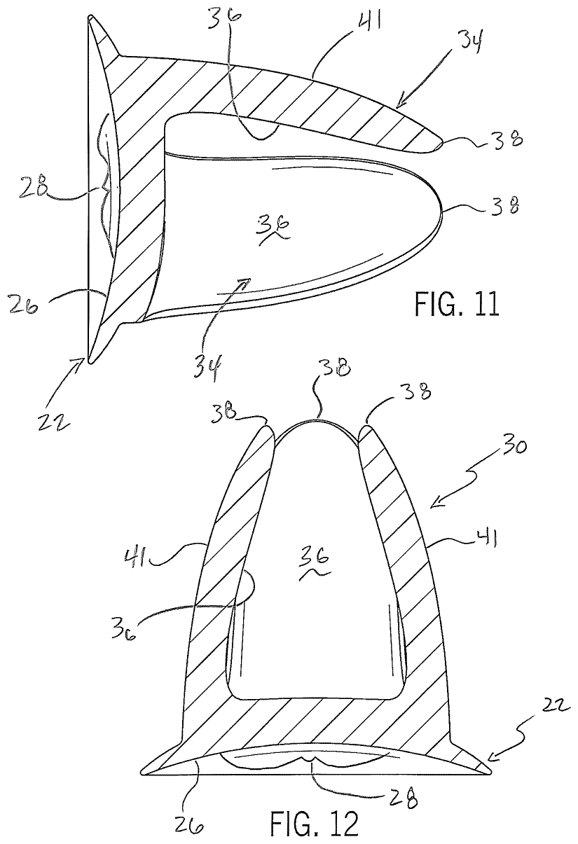

Turning now to the drawings. FIGS. 1-13 show an object holding device 20 in accordance with the teachings of the present disclosure. The object holding device 20, in one particular example, may be a luffa holding device, which is described in the disclosed example. However, the disclosed object holding devices may be used for holding different types of objects in many different types of environments. In this example, the object holding device 20 generally includes a base 22 having a holder side 24 and an attachment side 26. The object holding device 20 also includes an attachment feature 28 on the attachment side 26 and a holder 30 protruding from the holder side 24 of the base 22. The holder 30 forms a retention area A configured to hold (e.g., retain, store, etc.) an object, such as a luffa, a chamois, a tool, a utensil, or the like. The object holding device 20 is shown holding a luffa 32 in FIG. 2.

As illustrated in the drawings, the base 22 in one example is a circular shape. However, the base is not limited to a circular shape and may be rectangular, square, triangular, trapezoidal, oval, elliptical, polygonal, or any geometric shape. The base may also be uniquely shaped as any combination of these types of shapes.

The attachment feature 28 may be configured to retain the base 22 attached to a surface S. In one example, the attachment feature 28 retains the object holding device 20 to a surface S via suction. The attachment feature 28 may have a concave recess or suction cup shape or function. The concave recess in this example is configured to produce a suction force when the concave recess is pressed against a surface S to retain the base 22 attached to the surface via suction.

In another embodiment, the attachment side 26 of the base 22 may instead include a plurality of suction cups (not shown) formed thereon on or protruding therefrom to retain the base 22 attached to the surface S via suction. Furthermore, in another embodiment, the attachment side 26 may instead include an adhesive (e.g., glue, tape, epoxy, or the like) to retain the base 22 attached to the surface S.

As mentioned above, the base 22 of the object holding device 20 also includes a holder side 24, which carries the holder 30. The holder 30 protrudes from the holder side 24 of the base 22. In one example, the holder 30 includes two or more petals protruding from the holder side of the base. In one specific example, as illustrated in FIGS. 1-13, the holder 30 may include three petals 34 protruding from the holder side 24 of the base 22. The petals 34 are spaced apart from one another and have an inward facing surface 36 that generally face inward toward the direction of the other petals to define the retention area A. For example, the petals 34 may be spaced equidistant apart from one another circumferentially around the base 22.

Each petal 34 in the disclosed example may be concave at least on a portion or all of the inward facing surface 36 in a direction generally facing inward toward the other two of the three petals. The inward facing surface 36 of each respective petal 34 is curved generally concavely toward the center of the base 22, i.e., the central axis of the object holding device 20. For example, the center or middle of the inner surface 36 of the petal 34 is curved (e.g., arched) away from the center of the base 22, creating a cupped shape. Furthermore, each petal 34 may be concave along the length of the petal, i.e., from the base 22 to a tip or free or distal end 38 of the petal, concave across the width of the petal (i.e., from one side 40 to another side 40 of the petal), and/or a combination thereof. The petals 34 may also tilt and/or be curved inward toward one another from the base 22 to the tips 38, and outer surfaces 41 of the petals 34 may also be convexly curved in a lengthwise direction, a widthwise direction, or both, as shown.

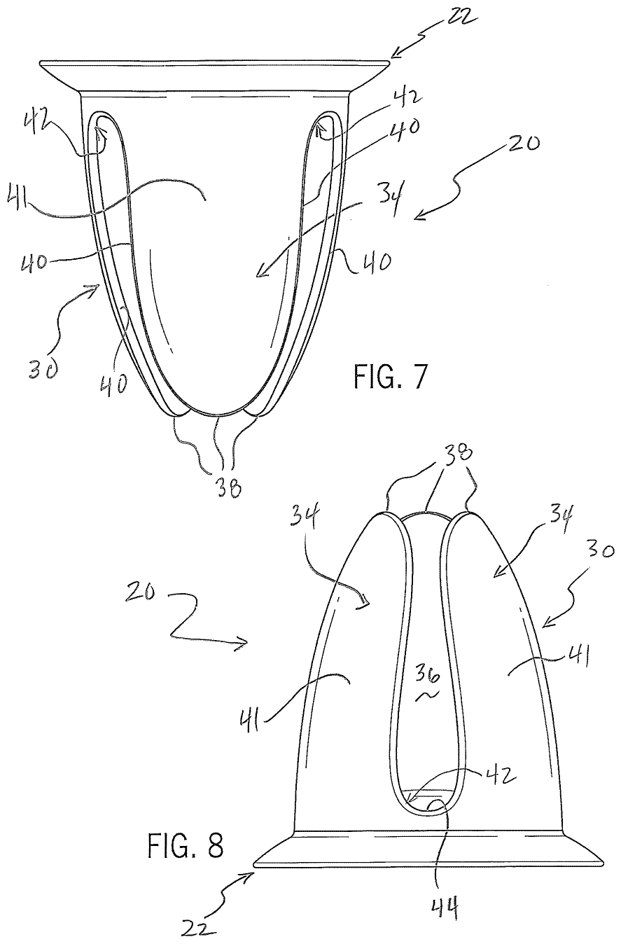

In the disclosed example, each petal 34 is integrally joined at its proximal end to the base 22. However, the sides 40 of each petal 34 may be joined to adjacent petals via a curved bridge 42 that may be at least partly elevated above the base 22, as best depicted in FIGS. 7-10. Alternatively, the sides 40 of each petal may extend toward and terminate at the base 22, eliminating the bridges 42, if desired. The bridges 42 may aid in stiffening the proximal ends of the petals 34. In this example, the center or inverse apex 44 of the bridges 42 between adjacent petals 34 may be flush with the surface of the base 22 on the holder side 24.

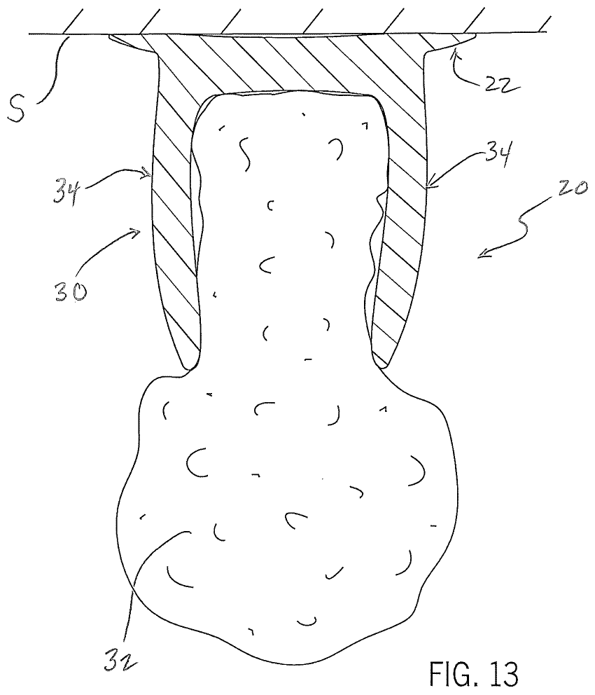

FIGS. 2 and 13 show the object holding device 20 holding an object 32 within the retention area A of the holder 30. In this example, the petals 34 are capable of bending or flexing outward to expand the retention area A to insert an object 32. The petals 34 can then resiliently return toward one another to close the width of the retention area and to grasp the object. Again, the object 32 can be a luffa, or can be another type of object, such as a car washing chamois, rag, or towel, a kitchen utensil, a tool, a mop head, a wash cloth, a steel wool pad, or the like,

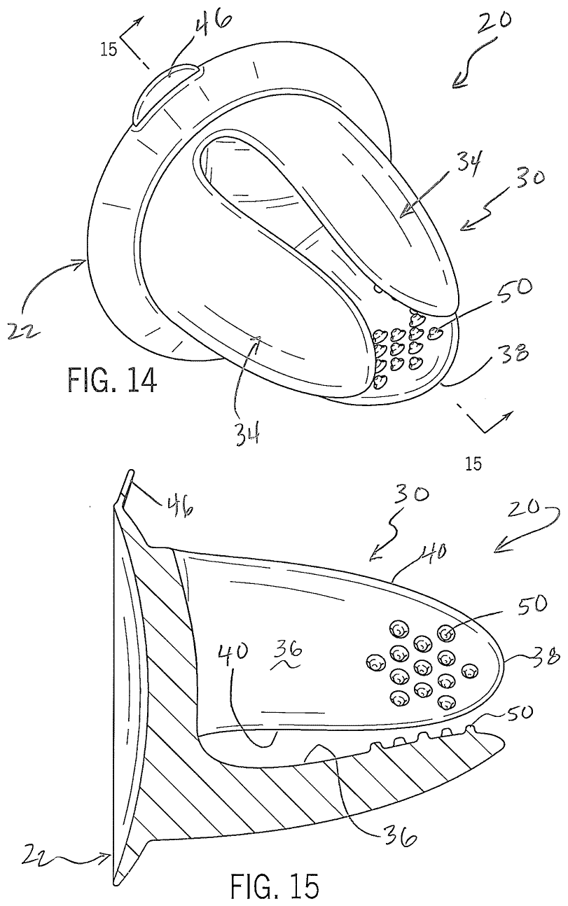

In one example, the base 22 may include a release tab 46, as shown in FIGS. 14-19, configured to release the base 22 attached to the surface S. The release tab 46 may be provided to advantageously allow for easy removal or release of the suction where the base has or defines a suction cup. In this example, the base 22 defines a suction cup and the tab is disposed on a side edge of the base. When the release tab 46 is pulled or lifted away from the surface S, the release tab breaks a seal between the attachment feature 28 and the surface S, releasing the suction and allowing the object holding device 20 to be easily removed.

Furthermore, each petal 34 of the holder 30 may include has a gripping feature, as shown in FIG. 14-19, to aid in retaining an object 32 in place when held in the retention area A. The gripping feature may include a plurality of protrusions that are exposed on and protrude from at least a part of the inward facing petal surfaces 36 to contact an object. The protrusions that may extend from the inward facing surface 36 of a part of each petal to form the gripping feature may be provided in a variety of configurations. The protrusions may be positioned nearer the tip 38, i.e., the free or distal end, of each petal 34. However, the protrusions may be disposed elsewhere along the petals 34, over a substantial portion of the inward facing surfaces 36 of the petals, and/or even along the edges near the sides 40 of the petals. In the disclosed examples, the protrusions may be positioned on at least a portion of the inward facing surface 36 near the tip 38 of each petal 34 so as to contact an object 32, such as a luffa, held in the retention area A. However, the protrusion may be placed anywhere on the inward facing surfaces 36 of the petals 34, may vary in size, height, and number, may vary in shape, and are not limited to the shapes described herein.

For example, in one embodiment, the gripping feature may be a plurality of cone-like bumps, bosses, or protrusions 50 extending from the inward facing surface 36 of each petal 34, as shown in FIGS. 14 and 15. In this example, each protrusion 50 of the plurality of protrusions is conical in shape, i.e., circular at a point adjacent the petal surface 36 and tapering to a more pointed vertex (e.g., apex). The protrusions 50 are positioned on only a portion of each petal 36 in this example. The portion includes from the tip 38 to nearer a midsection of the petal 34 and from near one side 40 or edge of the petal to near the other side 40 or edge of the petal (e.g., in a widthwise direction).

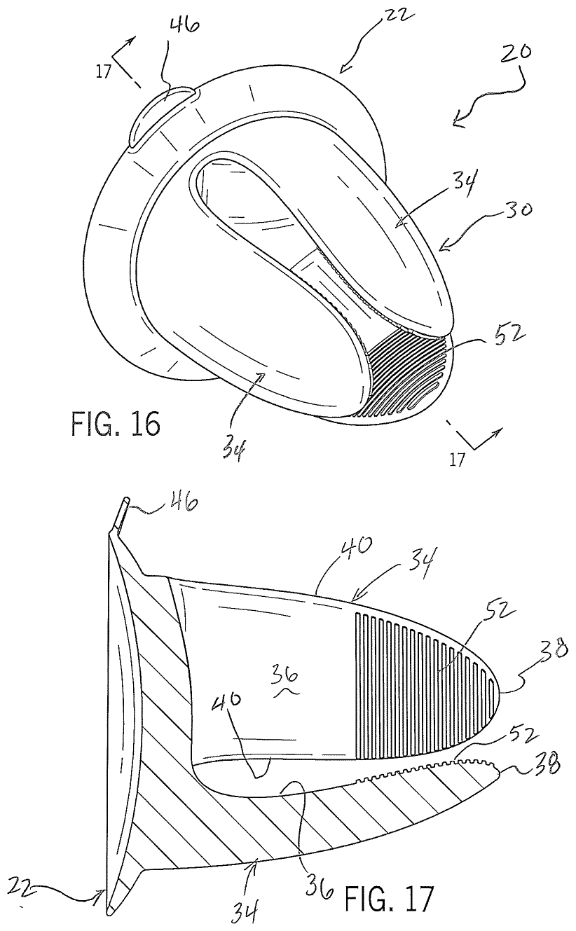

In another embodiment, the gripping feature may be a plurality of linear, spaced apart protrusions, ridges, or ribs 52 extending across a width from one side 40 to the other side 40 of each petal 34, as shown in FIGS. 16 and 17. In this example, the ribs 52 may have a triangular or rectangular shape in cross-section and may protrude outward from the inward facing surface 36 of each petal 34. The linear ribs are again positioned on only a portion of each petal 34. In this example, the ribs 52 are on a portion that extends from the tip 38 to near the midsection of each petal 34 and widthwise between and near the sides 40.

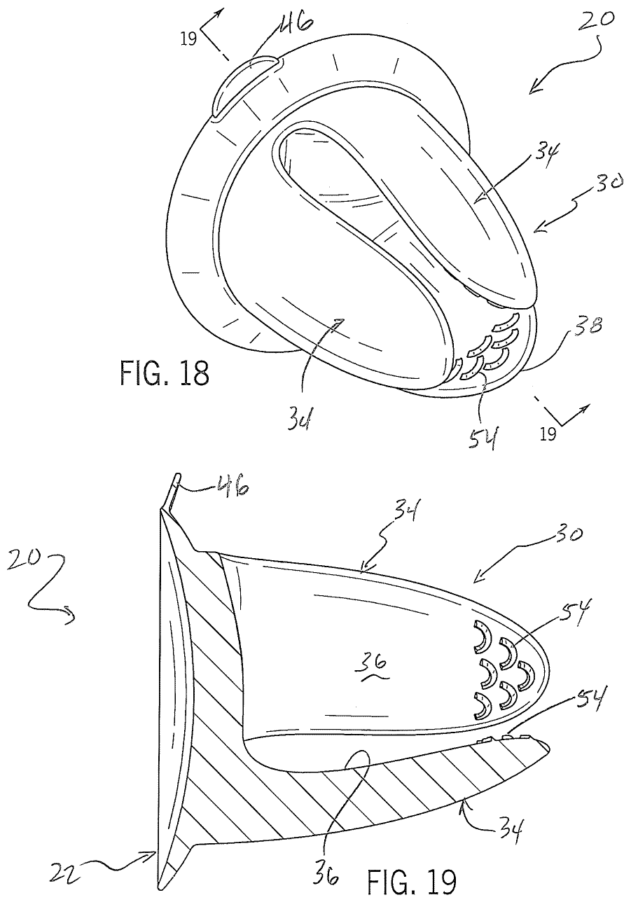

In yet another embodiment, the gripping feature may be a plurality of curved protrusions 54, as shown in FIGS. 18 and 19. The curved protrusions 54 protrude outward from the inward facing surface 36 of each petal 34. In cross-section, the curved protrusions 54 may be rectangular, semi-spherical, triangular, or the like. The curved protrusions 54 may again be positioned on only a portion of each petal 34. In this example, the curved protrusions 54 are on a portion that covers only a small area at and near the tip 38 of each petal 34 and from generally between the two sides 40 of the petal in the widthwise direction. In this example, each curved protrusion 54 is in the shape of a semi-circle, i.e., is C-shaped or U-shaped. Each protrusion 54 is positioned so that the concave aspect of the shape faces the base 22 of the object holding device 20. In other words, the opening of each semi-circle protrusion 54 is generally facing toward the base 22.

It is important to note that the positioning or orientation of the multiple gripping features is not limited to these embodiments. The gripping feature is intended to aid in holding an object, such as a luffa, that is placed in the retention area A. The resilient flexibility of the petals 34 and, in some examples, the concave shape of the confronting petals, along with the gripping feature, can assist in retaining an object placed in the retention area A.

Additionally, the base 22 and holder 30 of the object holding device 20 in one example may be integrally formed as one piece, thus simplifying the manufacturing procedures and lowering costs. The object holding device 20 in one example may be made from a water-resistant material, a flexible material, a rubber material, or a combination thereof. Such materials may be Acrylic, Polymethyl Methacrylate (PMMA), Polycarbonate (PC), Polyethylene (PE), Polypropylene (PP), Polyethylene Terephthalate (PETE or PET), Polyvinyl Chloride (PVC), Acrylonitrile-Butadiene-Styrene (ABS), and the like. Water-resistant material may be used to keep the object holding device dry at all times. Flexible material may be used to allow the object device 20 to be flexible when inserting an object 32 into the retention area A. However, the object holding device 20 is not limited to the flexible material and may instead be made from a more rigid material, as an object itself, such as a luffa, a chamois, or the like, may be compressed into the retention area A.

In the foregoing examples, the object holding devices may be configured to hold and/or grip an object, such as a luffa, while also being suctioned in place to a surface S. The object holding device 20 may be first suctioned to any suitable surface S. The surface S may be a tile surface, a tub surface, a shower stall surface, a glass door, a glass window, a metal surface, or a wood surface, a horizontal surface, a vertical surface, a partly inclined surface, or the like. The object holding devices may be placed at any desired height and may be oriented in any direction when the attachment side 26 of the base 22 is attached to a surface S. Once the object holding device 20 is attached to a surface S, an object 32, such as a luffa, may be inserted into the retention area A. The shape and resiliency of the petals 34, as well as the gripping feature, may be used to keep the object from falling out of the object holding device 20. Depending on the material of the object holding device 20, the object may be compressed into the retention area A of the object holding device and/or the petals 34 of the holder 30 of the device may be bent away for one another to open or expand the retention area A to allow an object to be placed into the retention area A.

The design and configuration of the various components of the object holding device can vary from those disclosed and described herein. The object holding device examples provided herein are described to illustrate various aspects of the disclosure. The examples are not intended to limit the disclosure to only those embodiments. Further, other examples may include more or fewer steps, components, and different combinations thereof than the examples shown and described herein.

Although certain features and components have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An object holding device comprising:
a base having a holder side and an attachment side;
an attachment feature on the attachment side; and
a holder protruding from the holder side,
wherein the holder forms a retention area configured to hold an object.

2. The object holding device of claim 1, wherein the attachment feature is a suction cup configured to retain the base attached to a surface via suction.

3. The object holding device of claim 1, wherein the attachment side further comprises a release tab configured to release the base attached to a surface via suction of the attachment feature.

4. The object holding device of claim 1, wherein the holder includes two or more petals protruding from the holder side of the base, and wherein the petals are spaced apart from one another to define the retention area.

5. The object holding device of claim 4, where the two or more petals comprise three petals spaced apart from one another, and wherein each petal has an inward facing surface facing generally toward the other two of the three petals.

6. The object holding device of claim 5, wherein the three petals are spaced equidistant apart from one another on the holder side of the base.

7. The object holding device of claim 5, wherein at least part of the inward facing surface of each petal is concave in a direction toward the other two of the three petals.

8. The object holding device of claim 1, wherein the holder has a gripping feature configured to aid in retaining an object in place when positioned in the retention area.

9. The object holding device of claim 8, wherein the gripping feature comprises a plurality of protrusions that protrude from an inward facing surface of a part of the holder.

10. The object holding device of claim 9, wherein:
the holder includes at least three petals protruding from the holder side of the base;
the at least three petals are spaced apart from one another to define the retention area; and
the plurality of protrusions protrudes from an inward facing surface of each petal of the at least three petals and are positioned at least nearer a distal or free end of each petal.

11. The object holding device of claim 1, wherein the base and holder are an integral one-piece molded structure.

12. The object holding device of claim 11, wherein the object holding device is made from a water-resistant material, a flexible material, a resilient material, a rubber material, or any combination thereof.

13. The object holding device of claim 1. wherein the base is a circular shape.

14. The object holding device of claim 13, wherein the base is configured to define a suction cup as the attachment feature.

15. The object holding device of claim 1. wherein the retention area of the holder is configured to hold a luffa.
